(19) United States
(12) Patent Application Publication
(10) Pub. No.: US 2025/0020050 A1
(43) Pub. Date: Jan. 16, 2025

(54) WELLHEAD SAND SEPARATION SYSTEM

(71) Applicant: ENERCORP ENGINEERED SOLUTIONS INC., CALGARY (CA)

(72) Inventor: Rory Nagge, Calgary (CA)

(21) Appl. No.: 18/770,921

(22) Filed: Jul. 12, 2024

Related U.S. Application Data
(60) Provisional application No. 63/513,672, filed on Jul. 14, 2023.

(51) Int. Cl. E21B 43/34; F15B 1/04

(52) U.S. Cl. CPC E21B 43/35; F15B 1/04

(57) ABSTRACT

A system includes a separator configured to receive a mixture of solids and fluid from a wellhead. The system also includes a first accumulator configured to receive the solids separated from the mixture by the separator. The system also includes a second accumulator configured to receive the solids from the first accumulator. The system also includes a transfer of rotation (TOR) device configured to receive a high-pressure, relative to a pressure in the first accumulator, fluid and to remove the solids from the first accumulator and deliver the solids to the second accumulator.

### CROSS-REFERENCE TO RELATED APPLICATIONS

This application claims priority to U.S. Provisional Patent Application No. 63/513,672, filed on Jul. 14, 2023, which is incorporated by reference.

### BACKGROUND

Hydraulic fracturing is a well-treatment process in which preferential flowpaths for hydrocarbons are established in a subterranean rock formation by pumping a fluid at high pressures into a well to initiate fractures in the rock formation. The fluid is predominately water, but may also include solids, such as sand or ceramic proppants, which at least partially fill the fractures and maintain the preferential flowpaths.

When oil or other fluids are produced/recovered from the well, it may be desirable to remove sand or other solids from the produced fluid. Typically, a separator system is used, which may include one or more separation devices (e.g., cyclonic separators), filters, screens, tanks, etc. The separator system is generally connected to a wellhead via pipes or tubing. The fluid thus flows from the well, into the wellhead, and then to the separator system, where the solids are separated out. The solids may be stored in a tank and periodically removed, while the fluids may be further separated (e.g., to separate hydrocarbons from water). Recovered hydrocarbons may be stored or otherwise transported for sale, and recovered water may be stored or otherwise recirculated for use in the well.

### SUMMARY

An example of a system includes a separator configured to receive a mixture of solids and fluid from a wellhead, a first accumulator configured to receive solids separated from the mixture by the separator, a second accumulator configured to receive the solids from the first accumulator, and a transfer of rotation (TOR) device configured to receive a high-pressure, relative to a pressure in the first accumulator, fluid and to remove solids from the first accumulator and deliver the solids to the second accumulator.

Another example of a system includes a separator configured to receive a mixture of solids and fluid from a wellhead, a first accumulator configured to receive solids separated from the mixture by the separator, and a second accumulator configured to receive the solids from the first accumulator. The second accumulator is maintained at a relatively low pressure relative to the first accumulator, such that a pressure differential causes the solids to move from the first accumulator to the second accumulator. The system further includes an isolation valve between the first and second accumulators. The isolation valve is configured to be opened to permit the movement of solids from the first accumulator to the second accumulator, and to be closed to permit fluid communication between the first and second accumulators. The system also includes a pump configured to deliver a liquid to the second accumulator, so as to remove solids therefrom.

Another example of a system includes a separator configured to receive a mixture of solids and fluid from a wellhead. The system also includes a first accumulator configured to receive the solids separated from the mixture by the separator. The system also includes a second accumulator configured to receive the solids from the first accumulator. The system also includes a transfer of rotation (TOR) device configured to receive a high-pressure, relative to a pressure in the first accumulator, fluid and to remove the solids from the first accumulator and deliver the solids to the second accumulator.

Another example of a system includes a separator configured to receive a mixture of solids and fluid from a wellhead. The system also includes a first accumulator configured to receive the solids separated from the mixture by the separator. The system also includes a second accumulator configured to receive the solids from the first accumulator. The second accumulator is maintained at a relatively low pressure relative to the first accumulator, such that a pressure differential causes the solids to move from the first accumulator to the second accumulator. The system also includes an isolation valve between the first and second accumulators. The isolation valve is configured to be opened to permit the movement of the solids from the first accumulator to the second accumulator, and to be closed to permit fluid communication between the first and second accumulators. The system also includes a pump configured to deliver a liquid to the second accumulator, so as to remove the solids therefrom.

An example of a method includes receiving a mixture of solids and fluid from a wellhead in a separator. The method also includes removing at least some of the solids from the mixture using the separator. The method also includes storing the removed solids in a first accumulator. The method also includes providing a high-pressure, relative to a pressure in the first accumulator, fluid to a transfer of rotation (TOR) device coupled to the first accumulator. Providing the high-pressure fluid to the TOR device causes the removed solids to be evacuated from the first accumulator. The method also includes delivering the removed solids from the TOR device to a second accumulator. The method also includes delivering the removed solids from the second accumulator to a sand disposal hopper, a sand cleaning system, or both.

Another example of a method includes receiving a mixture of solids and fluid from a wellhead in a separator. The method also includes removing at least some of the solids from the mixture using the separator. The method also includes storing the removed solids in a first accumulator. The method also includes providing a high-pressure, relative to a pressure in the first accumulator, fluid to a transfer of rotation (TOR) device coupled to the first accumulator. Providing the high-pressure fluid to the TOR device causes the removed solids to be evacuated from the first accumulator. The method also includes delivering the removed solids from the TOR device to a second accumulator. The method also includes delivering the removed solids from the second accumulator to a sand disposal hopper, a sand cleaning system, or both.

### BRIEF DESCRIPTION OF THE DRAWINGS

The present disclosure may best be understood by referring to the following description and the accompanying drawings that are used to illustrate embodiments of the invention. In the drawings:

FIG. 1 illustrates a schematic view of a sand separation system, according to an embodiment.

FIG. 2 illustrates a block diagram of a wellhead system, which may include components of the sand separation system discussed above, according to an embodiment.

FIG. 3 illustrates a block diagram of another embodiment of the wellhead system.

FIG. 4 illustrates a block diagram of another embodiment of the wellhead system.

FIG. 5 illustrates a block diagram of another embodiment of the wellhead system.

FIG. 6 illustrates a block diagram of another embodiment of the wellhead system.

FIG. 7 illustrates a block diagram of another embodiment of the wellhead system.

### DETAILED DESCRIPTION

The following disclosure describes several embodiments for implementing different features, structures, or functions of the invention. Embodiments of components, arrangements, and configurations are described below to simplify the present disclosure; however, these embodiments are provided merely as examples and are not intended to limit the scope of the invention. Additionally, the present disclosure may repeat reference characters (e.g., numerals) and/or letters in the various embodiments and across the Figures provided herein. This repetition is for the purpose of simplicity and clarity and does not in itself dictate a relationship between the various embodiments and/or configurations discussed in the Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the embodiments presented below may be combined in any combination of ways, e.g., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. In addition, unless otherwise provided herein, “or” statements are intended to be non-exclusive; for example, the statement “A or B” should be considered to mean “A, B, or both A and B.”

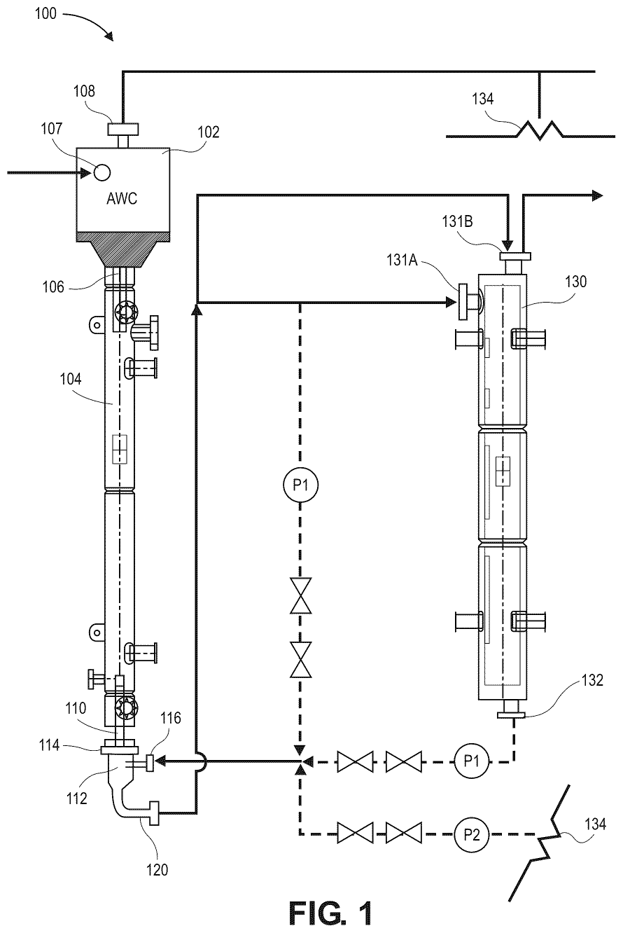

FIG. 1 illustrates a schematic view of a separation system 100, according to an embodiment. The separation system 100 may be configured to be connected to a wellhead, so as to separate sand and/or other solids from a mixture received from the wellhead, as will be described in greater detail below. The separation system 100 may generally include a separator 102, e.g., a cyclonic separator that creates a vortex, into which a slurry of solids (e.g., sand) and fluids is delivered for separation. The separation system 100 may also include a first accumulator 104. The separator 102 may be directly coupled to the first accumulator 104, such that solids (e.g., sand) are delivered into the first accumulator 104 via an open lower end 106 of the separator 102. The separator 102 may also have a fluids outlet 108, through which fluids (e.g., liquids) are delivered after having at least some of the solids separated therefrom. The separator 102 may also have an inlet 107 through which a mixture from the wellhead is received.

The solids delivered to the first accumulator 104 may settle towards a bottom of the first accumulator. An outlet 110 of the first accumulator 104 may be positioned at the bottom and may be configured to deliver the solids therethrough.

The separation system 100 may further include a transfer of rotation (TOR) device 112. The TOR device 112 may operate as both a passive mixer and a vortex pump. More particularly, the TOR device 112 may have a first inlet 114 that receives the solids from the first accumulator 104 and a second inlet 116 that receives a relatively high-pressure fluid from, e.g., a pump. A low-pressure region within the vortex develops in the high-pressure fluid, which draws the solids from the first accumulator 104 into the TOR device 112. The solids then mix with the vortically-flowing, high-pressure fluid, and the mixture is delivered to an outlet 120 of the TOR device 112.

From the outlet 120 of the TOR device 112, the mixture of solids and fluid is delivered to a second accumulator 130. The mixture may be received in the second accumulator 130 of the separation system 100 via one or more inlets (two shown: 131A, 131B), and reside therein until evacuated (in a process that may be referred to as a “blowdown”) via a blowdown outlet 132.

As indicated by dashed lines, one or more of at least three different sources for the high pressure fluid delivered to the TOR device 112 may be used. For example, a pump P1 may be fluidly coupled to a third accumulator 134. The third accumulator 134 may receive at least some of the fluid that flows out of the separator 102 via the fluids outlet 108. In another example, the pump P1 may be coupled to the blowdown outlet 132 of the second accumulator 130 and may receive fluid therefrom. In yet another example, the pump P1 may be connected to one of the inlets 131A of the second accumulator 130. In other examples, as will be discussed below, the high-pressure fluid can be received from other sources, e.g., from upstream of the separator 102. In each example, the pump P1 may increase the pressure of the fluid flowing therethrough, so as to deliver a relatively higher pressure fluid to the second inlet 116 of the TOR device 112.

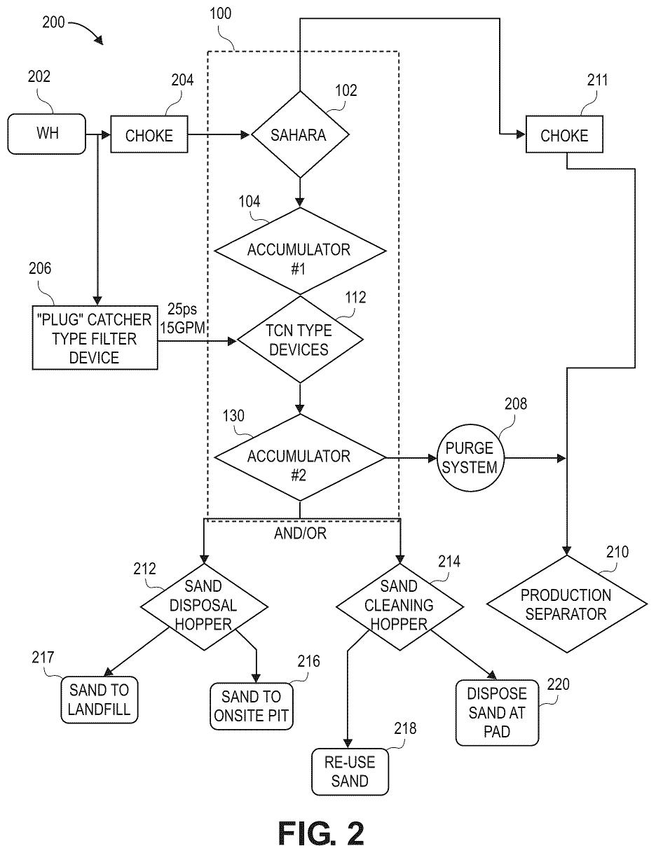

FIG. 2 illustrates a block diagram of a wellhead system 200, which may include components of the separation system 100 discussed above, according to an embodiment. In particular, as shown, the wellhead system 200 may include a wellhead 202, which may be connected to a well that is being treated. The wellhead system 200 may further include a choke 204 coupled to the wellhead 202. The choke 204 may produce a pressure drop, providing reduced-pressure fluid to the separation system 100, specifically, to the separator 102. Relatively high-pressure fluid (e.g., substantially at wellhead pressure) upstream of the choke 204 may be provided to the TOR device 112 (e.g., via a plug catcher or another filtering device 206). The relatively high-pressure fluid delivered to the TOR device 112 may be employed to move the solids from the first accumulator 104 to the second accumulator 130.

A purge system 208 may be coupled to the second accumulator 130, e.g., to reduce the pressure therein and/or otherwise remove fluid therefrom. The purged fluid may be provided to a production separator 210. The production separator 210 may also receive fluid from the separator 102, e.g., after the separator 102 has removed at least some of the solids (e.g., sand) therefrom, e.g., via a choke 211. The production separator 210 may further separate solids from the fluids.

Considering the second accumulator 130 again, during a blowdown operation, the solids (e.g., sand) therein may be provided to a sand disposal hopper 212 and/or to a sand cleaning system 214. The sand disposal hopper 212 may then provide the sand to a pit 216 or landfill 217. The sand cleaning system 214 may permit at least some of the sand to be reused, as indicated at 218, and/or the sand may be provided from the sand cleaning system 214 to a pit 220 (which may be the same or different from the pit 216).

In operation, a mixture of fluid and solids (e.g., sand) may leave the wellhead 202 and pass through the choke 204, which may be unrestricted. The mixture may enter the separator 102, where at least some of the solids are separated from the fluid and drop into the first accumulator 104. The solids may eventually fill the accumulator 104. The choke 204 may be activated, producing a pressure differential across the choke 204. By modulating valve positioning, fluid from upstream of the choke 204 may be routed to the TOR device 112, providing the high-pressure fluid that may permit the TOR device 112 to evacuate solids from the first accumulator 104 and move the solids to the second accumulator 130.

The high pressure fluid may eventually be stopped from flowing into the TOR device 112, e.g., when the first accumulator 104 is substantially emptied. The choke 204 may again be unrestricted and the mixture from the wellhead 202 again sent to the separator 102. Further, valves may be opened to purge gas and relieve pressure in the second accumulator 130 via the purge system 208 to a position downstream of the choke 211. The second accumulator 130 may then be isolated from the first accumulator 104. In at least some embodiments, pressure may be purged to atmospheric in the second accumulator 130. The sand and/or other solids in the second accumulator 130 may then be flushed to the sand disposal hopper 212, the sand cleaning system 214, or both. Further, gas may be purged from the second accumulator 130 via the purge system 208. When the first accumulator 104 is again filled, the process may repeat.

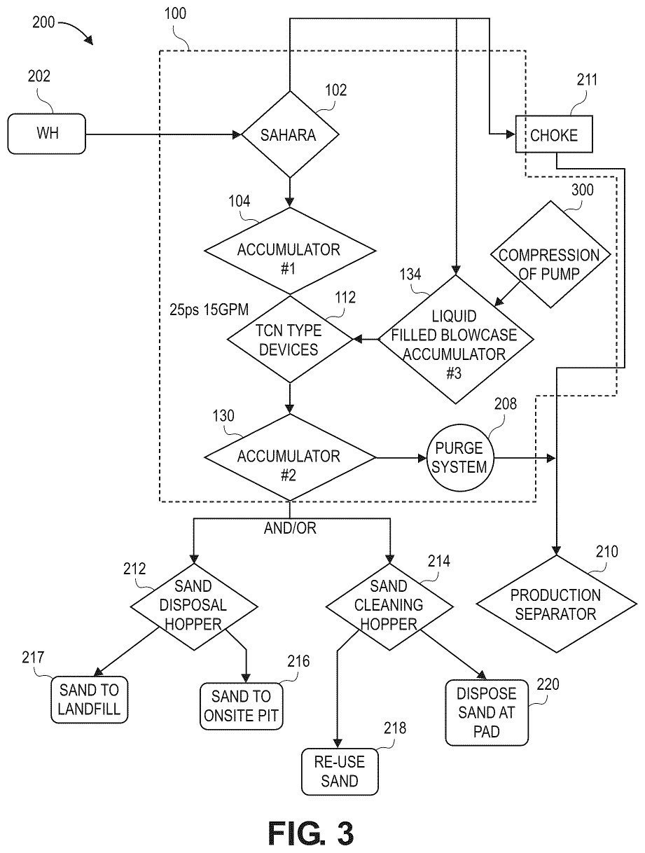

FIG. 3 illustrates another embodiment of the wellhead system 200. In this embodiment, the system includes the third accumulator 134 as well as a pump 300, which may be the pump P1 shown in and described above with reference to FIG. 1. Further, in this embodiment, the pump 300 may provide relatively high pressure fluid to the third accumulator 134, which may contain at least some of the fluid that is received via the fluid outlet 108 of the separator 102 (e.g., solids removed in the separator 102). The third accumulator 134 may be coupled to the TOR device 112, so as to provide the high-pressure fluid thereto and move the separated solids from the first accumulator 104 to the second accumulator 130.

In operation, a mixture of solids, gases, liquids, etc., may be received from the wellhead 202 into the separator 102. Solids may be separated from the fluid in the separator 102, and the solids may fall out into the first accumulator 104. The solids may eventually fill the first accumulator 104.

To remove sand from the first accumulator 104, liquid in the third accumulator 134 (e.g., a liquid-filled blowcase) may be pressured up to e.g., about 1.4 to about 4 times the pressure of the first accumulator 104 by the pump 300. The liquid in the third accumulator 134 may then be throttled into the TOR device 112 by opening one or more valves. Thus, the high pressure fluid is delivered to the TOR device 112, permitting the TOR device 112 to evacuate solids from the first accumulator 104 and send them to the second accumulator 130.

When the solids are removed from the first accumulator 104, the high-pressure flow to the TOR device 112 may be stopped. The purge system 208 may purge gas to relieve pressure to downstream of the choke 211 or to a flare system. The second accumulator 130 may then be isolated from the first accumulator 104. Pressure in the second accumulator 130 may also be purged to atmosphere, and the removed solids may be disposed of or recycled.

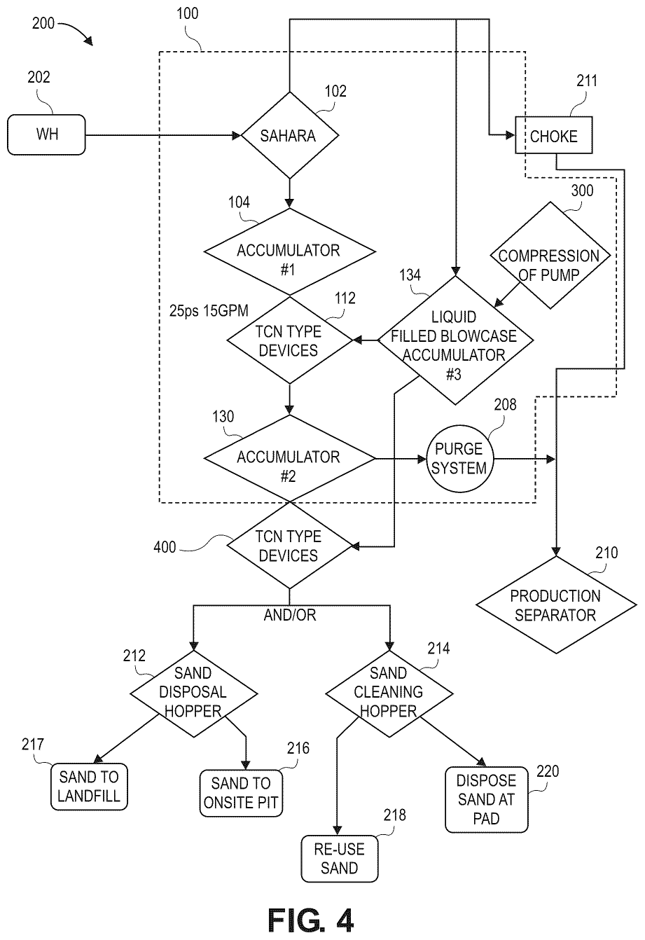

FIG. 4 illustrates another embodiment of the wellhead system 200. The wellhead system 200 of FIG. 4 may be like the wellhead system 200 of FIG. 3, with the addition of a second TOR device 400. The second TOR device 400 may be coupled to the third accumulator 134, e.g., in parallel to the first TOR device 112. The second TOR device 400 may thus be configured to receive a high-pressure fluid from the third accumulator 134, and may use the high-pressure fluid to move sand from the second accumulator 130 to the sand disposal hopper 212 and/or the sand cleaning system 214.

In operation, a mixture of gas, liquid, and solids (e.g., sand) may be received into the separator 102 from the wellhead 202. The separator 102 may remove at least some of the solids therefrom, which may drop into the first accumulator 104, and eventually may fill the first accumulator 104.

To evacuate the solids from the first accumulator 104, fluid from the third accumulator 134 (e.g., liquid-filled blowcase) may be pressured up, e.g., via the pump 300 to about 1.5 to about 4 times the pressure of the first accumulator 104. The fluid in the third accumulator 134 may then be throttled to the TOR device 112, thereby providing the high pressure fluid to the TOR device 112, which moves the solids from the first accumulator 104 to the second accumulator 130. Gas from the second accumulator 130 may then be purged via the purge system 208, and the second accumulator 130 may again be isolated from the first accumulator 104. Solids in the second accumulator 130 may then be stored, recycled, or disposed of.

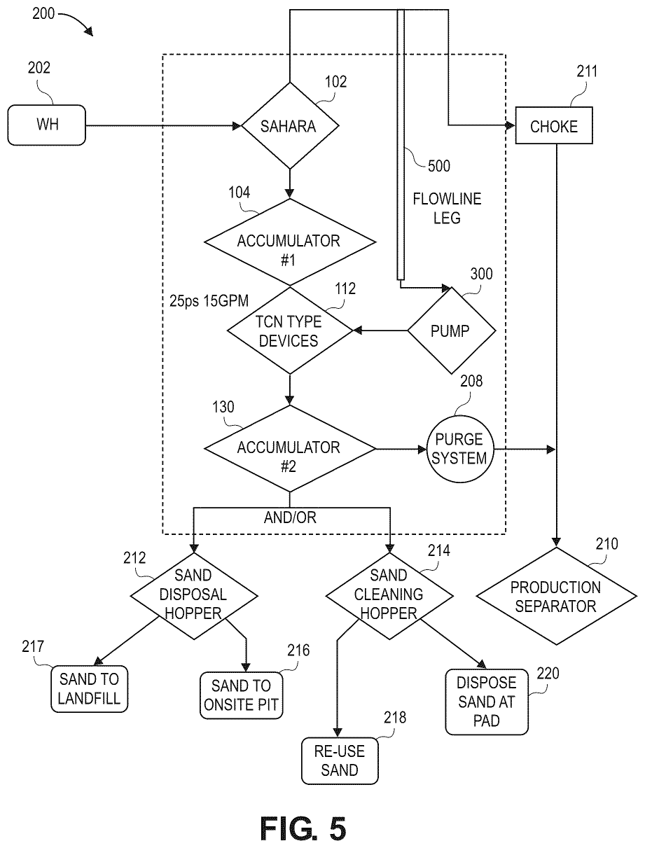

FIG. 5 illustrates another embodiment of the wellhead system 200. The wellhead system 200 of FIG. 5 may be the same as the wellhead system 200 of FIG. 3, except the third accumulator 134 is omitted. In this embodiment, the pump 300 may provide the high-pressure fluid directly to the TOR device 112. A flowline leg 500 may be provided to hold fluid removed from the fluid outlet 108 of the separator 102. The flowline leg 500 may be a branch off the regular line to accumulate a certain amount of liquid to run a cycle of the pump 300 so as to flush the sand out of first accumulator 104. A spool or a small accumulator vessel may be used in place of the flowline in some embodiments.

In operation, a mixture of solids, liquid, and gas may be provided from the wellhead 202 to the separator 102. The solids may be separated from the mixture by the separator 102, and the solids may drop into the and eventually fill the first accumulator 104. Some of the fluid, from which at least some of the solids are removed in the separator 102, may then be provided to the pump 300, which may provide the pressurized fluid to the TOR device 112. The TOR 112 may use the high pressure fluid to evacuate the solids from the first accumulator 104 and provide the solids to the second accumulator 104. The second accumulator 130 may then be purged using the purge system 208, and the second accumulator 130 may be again isolated from the first accumulator 104. The second accumulator 130 may optionally also be purged to atmosphere. The remaining solids, liquids and pressure may the drained, purged, and/or flushed to the system of choice.

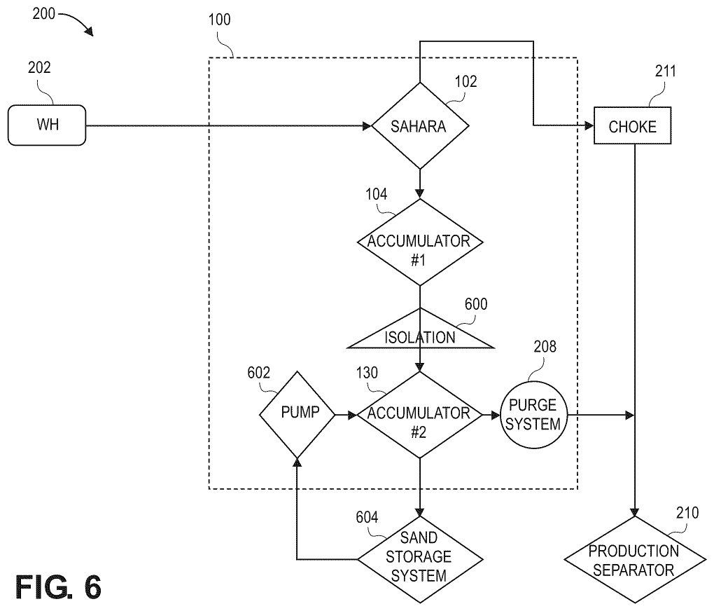

FIG. 6 illustrates a block diagram of another embodiment of the wellhead system 200. The wellhead system 200 of FIG. 6 may be similar to the wellhead system 200 of FIG. 3, but may omit the TOR device 112. The wellhead system 200 of FIG. 6 may also include, as shown, an isolation valve 600, a pump 602, and a sand storage system 604. The isolation valve 600 may be positioned between the first accumulator 104 and the second accumulator 130. Further, the pump 602 may provide fluid to flush out sand from the second accumulator 130, e.g., from a fresh water source or recycled water from previous flush cycles from the sand storage system 604.

The solids may move between the first and second accumulators 104, 130 by a pressure differential that develops therebetween, e.g., the second accumulator 130 may be at a relatively low pressure as compared to the first accumulator 104. This pressure differential may provide the energy that moves the solids (e.g., sand) from the first accumulator 104 to the second accumulator 130. The isolation valve 600 being between the first and second accumulators 104, 130 may permit the isolation valve 600 to be opened to permit the movement of solids from the first accumulator 104 to the second accumulator 130, and to be closed to prevent fluid communication between the first and second accumulators 104, 130.

In operation, a mixture of gas, liquid, and solids (e.g., sand) may be received into the separator 102 from the wellhead 202. The separator 102 may remove the solids therefrom, which may drop into the first accumulator 104, and eventually may fill the first accumulator 104.

In this embodiment, the isolation valve 600 (multiple valves may be employed) may be opened and sand may be purged to the second accumulator 130, which may be held generally at atmospheric pressure, below the pressure within the first accumulator 104. The second accumulator 130 may then be isolated from the first accumulator 104 via the isolation valves 600, e.g., when the solids have substantially been removed from the first accumulator 104 and delivered to the second accumulator 130. The second accumulator 130 may then be purged to a low pressure (e.g., atmospheric) location, and water may be pumped to flush solids from the second accumulator

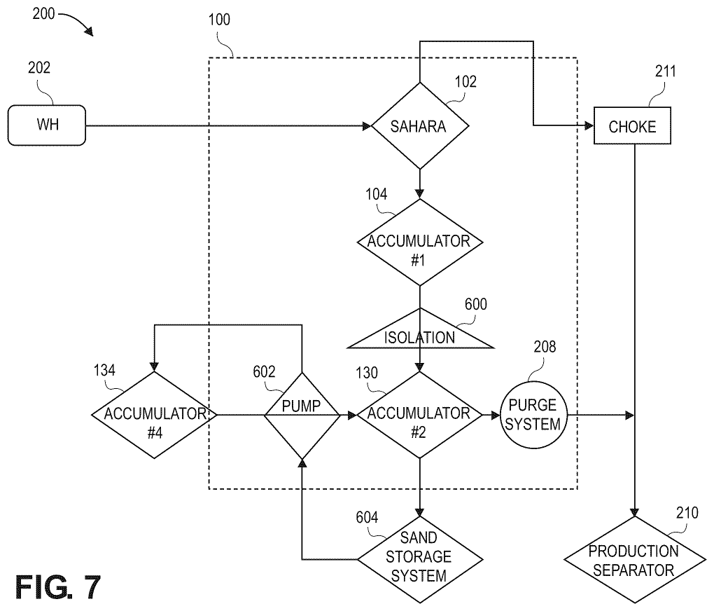

FIG. 7 illustrates a block diagram of another embodiment of the wellhead system 200. This embodiment may be similar to the embodiment shown in FIG. 6, with the addition of the third accumulator 134. As shown, the third accumulator 134 may be coupled to the pump 602, which may provide a pressurized fluid thereto, from the second accumulator 130. The third accumulator 134 may hold the pressurized fluid, until it is delivered back to the second accumulator 130.

This embodiment may also operate like the embodiment shown in FIG. 6. In addition, at least some of the fluid in the second accumulator 130 may be stored in the third accumulator 134, e.g., after being pressurized by the pump 602. To clean out the second accumulator 130, the fluid (e.g., water from previous cycles) may be delivered to the second accumulator 130 from the third accumulator 134.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A system, comprising:
a separator configured to receive a mixture of solids and fluid from a wellhead;
a first accumulator configured to receive the solids separated from the mixture by the separator;
a second accumulator configured to receive the solids from the first accumulator; and
a transfer of rotation (TOR) device configured to receive a high-pressure, relative to a pressure in the first accumulator, fluid and to remove the solids from the first accumulator and deliver the solids to the second accumulator.

2. The system of claim 1, further comprising a choke that is upstream of the separator, wherein the TOR device is configured to receive the high-pressure fluid from upstream of the choke.

3. The system of claim 1, wherein the TOR device is configured to receive the fluid from the separator, after the separator has separated at least some of the solids from the mixture.

4. The system of claim 3, further comprising:
a flowline configured to receive the fluid from the separator; and
a pump configured to pressurize the fluid and deliver the fluid to the TOR device.

5. The system of claim 3, further comprising:
a third accumulator that is configured to receive the fluid from the separator; and
a pump configured to increase a pressure of the fluid received in the third accumulator, wherein the TOR device is configured to receive the fluid from the third accumulator.

6. The system of claim 5, wherein the TOR device is a first TOR device, the system further comprising a second TOR device that is coupled to an outlet of the second accumulator.

7. The system of claim 6, wherein the second TOR device is configured to receive the fluid from the third accumulator and to move the solids from the second accumulator to a sand disposal hopper, a sand cleaning system, or both.

8. The system of claim 1, further comprising a production separator downstream of the separator, wherein the production separator is configured to further separate the solids from the fluid.

9. The system of claim 1, further including a pump configured to increase a pressure of the fluid received in the second accumulator.

10. A system, comprising:
a separator configured to receive a mixture of solids and fluid from a wellhead;
a first accumulator configured to receive the solids separated from the mixture by the separator;
a second accumulator configured to receive the solids from the first accumulator, wherein the second accumulator is maintained at a relatively low pressure relative to the first accumulator, such that a pressure differential causes the solids to move from the first accumulator to the second accumulator;
an isolation valve between the first and second accumulators, wherein the isolation valve is configured to be opened to permit the movement of the solids from the first accumulator to the second accumulator, and to be closed to permit fluid communication between the first and second accumulators; and
a pump configured to deliver a liquid to the second accumulator, so as to remove the solids therefrom.

11. The system of claim 10, wherein the liquid comprises water that was previously in the second accumulator and has been recycled.

12. The system of claim 10, further comprising a third accumulator configured to receive the liquid from the pump and to deliver the liquid to the second accumulator.

13. The system of claim 10, wherein the solids that are removed from the second accumulator are delivered to a sand disposal hopper, a sand cleaning system, or both.

14. A method, comprising:
receiving a mixture of solids and fluid from a wellhead in a separator;
removing at least some of the solids from the mixture using the separator;
storing the removed solids in a first accumulator;
providing a high-pressure, relative to a pressure in the first accumulator, fluid to a transfer of rotation (TOR) device coupled to the first accumulator, wherein providing the high-pressure fluid to the TOR device causes the removed solids to be evacuated from the first accumulator;
delivering the removed solids from the TOR device to a second accumulator; and
delivering the removed solids from the second accumulator to a sand disposal hopper, a sand cleaning system, or both.

15. The method of claim 14, wherein providing the high-pressure fluid to the TOR device comprises:
restricting a choke between the wellhead and the separator; and
directing at least some of the mixture from the wellhead to the TOR device from a position upstream of the choke.

16. The method of claim 14, further comprising purging the first accumulator to a position downstream of a choke that is downstream of the separator and upstream of a production separator.

17. The method of claim 14, wherein providing the high-pressure fluid to the TOR device comprises directing at least some of the fluid from the separator to the TOR device.

18. The method of claim 17, wherein the at least some of the fluid is received into a flowline and pressurized by a pump.

19. The method of claim 17, wherein directing the at least some of the fluid from the separator to the TOR device comprises:
receiving the at least some of the fluid into a third accumulator;
increasing a pressure in the third accumulator to produce the high-pressure fluid; and
providing the high-pressure fluid to the TOR device from the third accumulator.

20. The method of claim 19, wherein the TOR device is a first TOR device, and wherein delivering the removed solids from the second accumulator to the sand disposal hopper, the sand cleaning system, or both comprises providing the high-pressure fluid from the third accumulator to a second TOR device coupled to an outlet of the second accumulator.
